(19) United States
(12) Patent Application Publication
(10) Pub. No.: US 2006/0031170 A1
(43) Pub. Date: Feb. 9, 2006

(54) Application and license proxy process using shared memory

(76) Inventor: Daven Walt Septon, Loveland, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/899,832

(22) Filed: Jul. 26, 2004

(51) Int. Cl. G06Q 99/00

(52) U.S. Cl. 705/59

(57) ABSTRACT

A license request for an application is transmitted from a license proxy process to a license server. A license from the license server is then received at the license proxy process. Thereafter, the license proxy process stores license information corresponding to the license in memory that is shared by the application and the license proxy process.

### BACKGROUND

License servers are used to manage licenses that enable or enhance capabilities of applications. The licenses issued by a license server may comprise “node lock” licenses that are issued to a single machine, or “floating” licenses, which are not machine specific. As illustrated in FIG. 1, an application 100 may issue a request for a license to the license server 110. If a license is available, the license server 110 may then issue the license to the application 100.

To maintain compliance with licensing agreements, the license server 110 may track the number of licenses it issues. However, if the license server 110 fails, it may lose its knowledge of issued licenses and, upon restart, its entire quantity of licenses may once again be made available. If one or more applications obtained licenses before the license server failure, and the license server reissues these licenses to additional applications after it is restarted, license over-usage becomes possible.

In order to prevent license over-usage, a heartbeat may be sent from the application 100 to the license server 110 at predetermined time intervals. If the license server 110 fails, the application 100 will not receive an acknowledgement to its heartbeat, and appropriate action can be taken.

For circuit test applications that rely on licenses provided by a FLEX/m™ license server (a license server offered by Macrovision Corporation, a Delaware Corporation having its principal place of business in Santa Clara, Calif., USA), the heartbeats provided by the circuit test applications may be executed within a few milliseconds. However, if a circuit test application is executing tests within nanoseconds, or even picoseconds, a few milliseconds is a long time, and the application's need to execute heartbeats can degrade the application's performance. Similar performance degradation is also suffered by other applications that need to provide license heartbeats during their execution of time-critical processes. In the past, programmers have merely suffered the performance “hit” of heartbeat execution; or, programmers have circumvented or disabled an application's need to provide heartbeats. In the latter case, a user of the application may fail to comply with their license requirements.

### SUMMARY OF THE INVENTION

In one embodiment, a license request for an application is transmitted from a license proxy process to a license server. A license from the license server is then received at the license proxy process. Thereafter, the license proxy process stores license information corresponding to the license in memory that is shared by the application and the license proxy process.

Other embodiments are also disclosed.

### BRIEF DESCRIPTION OF THE DRAWINGS

Illustrative and presently preferred embodiments of the invention are illustrated in the drawings, in which:

FIG. 1 illustrates a prior art system that may be used by an application to obtain licenses;

FIG. 2 illustrates an exemplary embodiment of a system that uses a license proxy process and shared memory to obtain licenses and store license information;

FIG. 3 illustrates a circuit tester that employs the license proxy process and shared memory of FIG. 2;

FIG. 4 illustrates an exemplary method for obtaining licenses and storing license information;

FIG. 5 illustrates an application's exemplary retrieval of license information stored by the FIG. 4 method; and

FIG. 6 illustrates an exemplary method that may be implemented by the license proxy process of FIGS. 2 or 3 to transmit heartbeats to a license server.

### DETAILED DESCRIPTION OF THE INVENTION

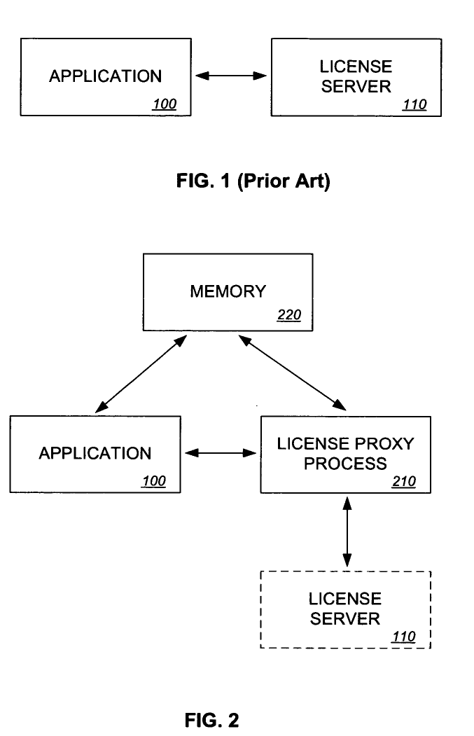

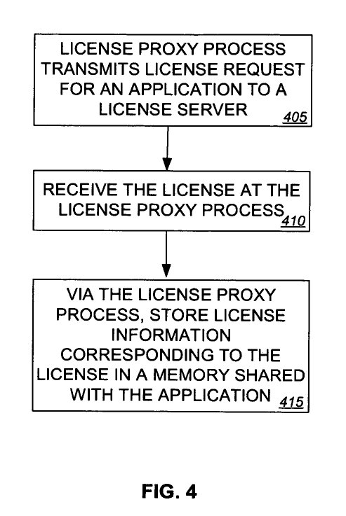

An exemplary embodiment of a system that uses a license proxy process to obtain licenses and store license information is illustrated in FIG. 2. The system comprises an application 100 that is communicatively coupled to a license proxy process 210. As defined herein, a communicative coupling is any sort of coupling that allows for communication between two processes. By way of example, a communicative coupling may comprise a socket or other software coupling, and/or a bus, cable, network, wireless mechanism, or other mechanism. Thus, it should be appreciated that license proxy process 210 and application 100 may reside on the same or different machines. It should also be appreciated that, in some embodiments, the application 100 may be a component (e.g., a process) of a larger application. As will be described in further detail below, with reference to FIGS. 4 and 6, the license proxy process 210 may be responsible for obtaining licenses for the application 100, and periodically transmitting heartbeats to a license server 110.

The license proxy process 210 is communicatively coupled to the license server 110. By way of example, the license server 110 may be a FLEX/m™ license server. However, the license server 110 may also take other forms. The license server 110 may be used to issue and control licenses for one or more applications, including application 100. Licenses issued by the license server 110 may be used to enable applications, or to enhance or govern the capabilities of applications (including the capabilities of hardware and firmware that may be controlled by the applications). In one embodiment, the license proxy process 210 is launched or initialized upon launch of the application 100.

The system further comprises a shared memory 220 that is communicatively coupled to application 100 and the license proxy process 210. The memory 220 may be used to store license information corresponding to one or more licenses that are obtained from the license server 110. License information may comprise the license type, the application and/or feature for which the license was issued, and/or other application specific information or types of information needed by application 100. It should be appreciated that, in some embodiments, the license information may comprise the license obtained from license server 110. Alternately, the license information may simply be an indication that a license has been obtained (e.g., a Boolean flag).

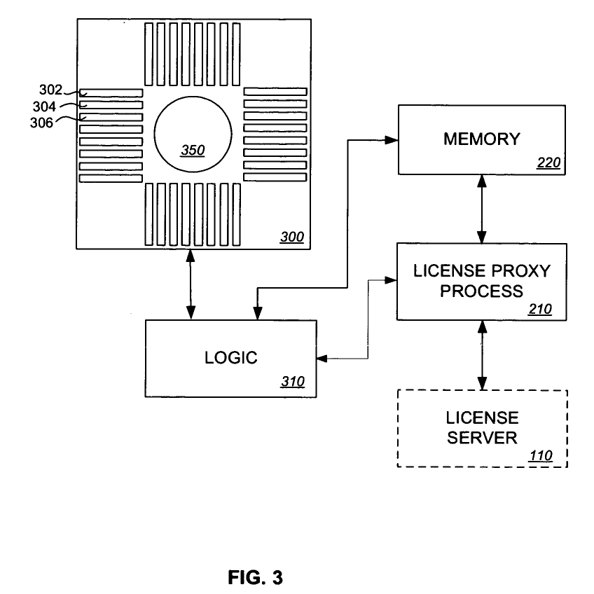

An exemplary circuit tester 300 that employs the license proxy process 210 is illustrated in FIG. 3. As shown, the circuit tester 300 may be configured to test a device 350, such as a system-on-a-chip (SOC) or other type of circuit. It should be appreciated that, at times, tester 300 may need to execute licensed applications while not coupled to a device 350.

As shown, tester 300 may comprise a plurality of boards 302-306. Each board may comprise a plurality of pins for driving inputs to, and receiving outputs from, device 350. In one embodiment, each pin may be associated with its own memory for storing test stimuli or test results (e.g., pin-specific vector information). In alternate embodiments of the tester 300, a dedicated memory may not be provided for each pin, but may instead be included for each board or other component of tester 300.

The circuit tester 300 may also comprise logic 310 that is communicatively coupled to tester 300. Logic 310 may be part of a test operating system or application that is installed on a workstation coupled to tester 300 via a communication link such as an optical link. In this manner, logic 310 may be used to control and enable features of the tester 300. In one embodiment, logic 310 may communicate with firmware on tester 300 to both 1) send tests to device 350, and 2) receive test results from device 350. In an alternate embodiment, logic 310 may be part of the firmware of tester 300.

A license may be required to enable the tester 300, or to enable or govern one or more capabilities of the tester 300. By way of example, a license may be used to enable all of the capabilities of the tester 300 or may be used to grant limited use of resources (e.g., limited rights to use boards, pins, memory or functionality (e.g., speed, GUIs, algorithms, test development tools, or debug techniques)) of the tester 300. As will be described in further detail below, with reference to FIG. 4, logic 310 may obtain one or more licenses from the license server 110 using a license proxy process 210, and then store license information for logic 310 in shared memory 220. After a license has been obtained, the license proxy process 210 may then be used to issue heartbeat communications to the license server 110.

FIG. 4 illustrates an exemplary method that may be used to obtain a license for an application 100 using the license proxy process 210. First, a license request is transmitted 405 from the license proxy process 210 to the license server 110. Ideally, this is done before the license is needed by the application 100. However, it may also be done at the time a license is needed. In response to the request, the license proxy process 210 receives 410 a license from the license server 110. It should be appreciated that before issuing the license, the license server 110 may check to make sure that a license is available. In an alternate embodiment, a license may not be available and, instead of receiving 410 a license, the license proxy process 210 may instead receive a notification from the license server 110 that no license is available.

After the license is received 410, the license proxy process 210 stores 415 license information corresponding to the license in shared memory 220. As previously described, the license information may include the license itself, a Boolean flag, and/or other types of information that may be needed by the application. In one embodiment, after a license has been received 410, an indication may be sent from the license proxy process 210 to the application 100 to notify the application 100 that a license has been obtained. Alternately, the application 100 may read the memory 220 whenever it requires a license. If license information is not present, the application 100 may cause the license proxy process 210 to obtain a license, and then periodically poll the memory 220 to determine if license information has been obtained; or, the application 100 may merely wait until it receives an indication from the license proxy process 210 that a license has been obtained. In some embodiments, the license proxy process 210 may proactively obtain a license for application 100 before it is required by the application 100.

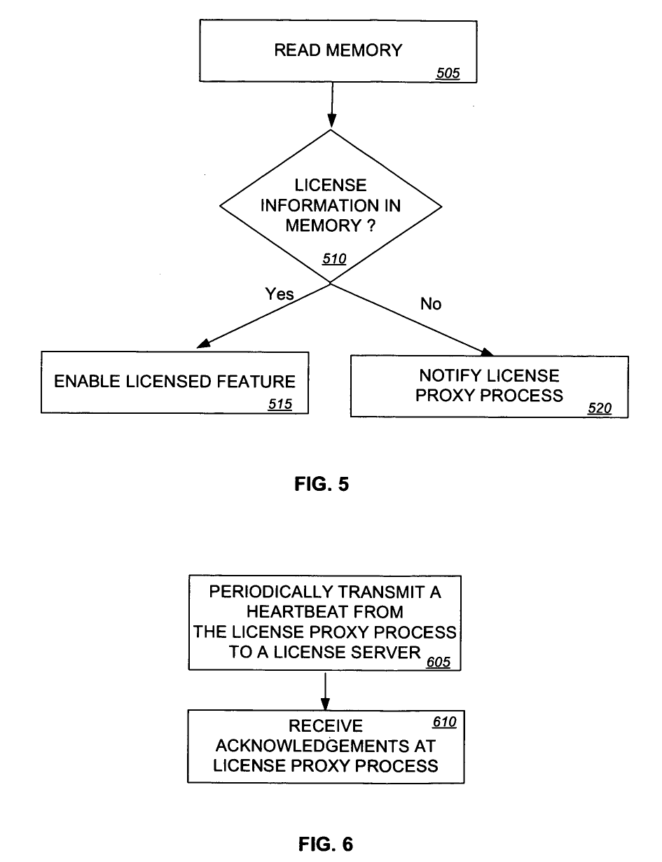

FIG. 5 illustrates an exemplary method that may be used by application 100 to determine if a license has been obtained. When the application 100 determines a license is required, it reads 505 a memory 220 shared with the license proxy process 210. If 510 the memory 220 contains license information for the application 100, the application can proceed with the enablement 515 of licensed features for which the license was required. Otherwise, if 510 the memory 220 does not contain license information, a license request can be transmitted 520 to the license proxy process 210 so that the license proxy process 210 can obtain the license needed by the application 100.

In some embodiments, memory 220 may reduce the number of times an application 100 needs to request a license. By way of example, logic 310 may not know that it has a license when device 350 is replaced with a device of the same configuration (copy of device 350). If memory 220 is not used, logic 310 may request a license hundreds of times during device testing, even though a license has previously been obtained for the testing. Thus, it should be appreciated that by using memory 220, the overhead involved in the licensing process may be greatly reduced.

FIG. 6 illustrates an exemplary method that may be used by the license proxy process 210 to transmit 605 heartbeats to the license server 110. The heartbeat may be transmitted at predetermined time intervals so as to discover failures of the license server 110. If the license server 110 is running, the license server 110 may send an acknowledgement for each of the periodic heartbeats of the license proxy process 210. If the license server 110 fails, the license proxy process 210 will not receive 610 an acknowledgement to its heartbeat.

In some embodiments, if an acknowledgement to a heartbeat is not received, the license under which the application 100 is running may no longer be valid (e.g., because the license server 110 may have released all of its licenses during a failure). If the license proxy process 210 determines that a license indication is no longer valid, either because it failed to receive an acknowledgement to its heartbeat, or for some other reason, the license proxy process 210 can then take appropriate action. By way of example, “appropriate action” may take the form of notifying the application 100, and/or attempting to reacquire a license from the license server 110. In some embodiments, the application 100 may be allowed to continue running, while in other embodiments, the application 100 may be halted until a valid license can be reacquired.

The heartbeat transmitted by the license proxy process 210 may be used to help prevent license over-usage. The heartbeat transmittal 605 may also serve as a notification to the license server 110 that a license is being used by the application 100, and may serve to trigger an automatic reissue of the license to the license proxy process 210 after a restart of license server 110 following a failure. It should be appreciated that by using a license proxy process 210 to communicate heartbeats to the license server 110, license over-usage may be prevented with minimal or no impact on the performance of application 100.

After the application 100 has finished using a license (e.g., because logic 310 has finished executing tests on tester 300), the application 100 may send a notification to the license proxy process 210 that the license is no longer needed. The license proxy process 210 may then transmit a request to free the license to the license server 110. In one embodiment, this may be done by forwarding the notification received from the application 100. The license server 110 may then make the license available to other applications. Additionally, after the application 100 has finished using the license, either the license proxy process 210 or the application 100 may remove the license information from the memory 220.

The methods described above may be performed by hardware components, or may be embodied in sequences of machine-executable instructions that may be used to cause a machine, such as a general-purpose or special-purpose processor, or logic circuits programmed with the instructions, to perform the actions of the methods. Alternatively, the methods may be performed by a combination of software, firmware, and/or hardware.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method, comprising:
transmitting a license request for an application from a license proxy process to a license server;
receiving, at the license proxy process, a license from the license server; and
via the license proxy process, storing license information corresponding to the license in memory shared by the application and the license proxy process.

2. The method of claim 1, further comprising, after receiving the license, periodically transmitting a heartbeat from the license proxy process to the license server.

3. The method of claim 2, further comprising, receiving from the license server, at the license proxy process, an acknowledgment of at least one of the periodic heartbeats.

4. The method of claim 1, further comprising:
receiving, at the license proxy process, a notification from the application that the license is no longer needed; and
after receiving the notification, transmitting a request to free the license from the license proxy process to the license server, and removing said license information from the memory.

5. The method of claim 1, wherein said license request is transmitted before the application requires the license.

6. A method comprising:
from an application, reading a memory shared with a license proxy process; and
if the memory does not contain license information for the application, causing a license request to be transmitted from the license proxy process to a license server.

7. The method of claim 6, further comprising:
after transmission of the license request, receiving, at the license proxy process, a license from the license server; and
via the license proxy process, storing license information corresponding to the license in the memory.

8. The method of claim 6, further comprising, if the memory contains the license information, enabling one or more features of a circuit tester.

9. The method of claim 6, further comprising, if the memory contains the license information, periodically transmitting a heartbeat from the license proxy process to the license server.

10. The method of claim 9, further comprising, receiving from the license server, at the license proxy process, an acknowledgement of at least one of the periodic heartbeats.

11. A system comprising:
an application;
a license proxy process, communicatively coupled to the application, to obtain a license for the application from a license server; and
a memory, communicatively coupled to the application and the license proxy process, to store license information corresponding to the license.

12. The system of claim 11, further comprising the license server, communicatively coupled to the license proxy process to issue said license for the application.

13. The system of claim 12, wherein the license proxy process is further configured to, after receipt of said license, periodically transmit a heartbeat to the license server.

14. The system of claim 13, wherein the license server is further configured to transmit an acknowledgement of at least one of the periodic heartbeats.

15. The system of claim 11, wherein the application comprises logic to enable features of a circuit tester.

16. The system of claim 15, further comprising the circuit tester, communicatively coupled to the logic.

17. The system of claim 16, wherein the circuit tester comprises a system-on-a-chip (SOC) tester.
